(19) United States
(12) Patent Application Publication
(10) Pub. No.: US 2011/0060826 A1
(43) Pub. Date: Mar. 10, 2011

(54) DETECTING AND DETERMINING AVAILABILITY OF A NETWORK STRUCTURE WITH ACTIVE CONNECTION NODES

(76) Inventors: Klaus Reister, Dettingen/Teck (DE); Oliver Schmerling, Lehrte (DE); Karl-Heinz Niemann, Hannover (DE)

(21) Appl. No.: 12/875,365

(22) Filed: Sep. 3, 2010

(30) Foreign Application Priority Data
Sep. 4, 2009 (DE) 102009040265.9

(51) Int. Cl. G06F 15/173

(52) U.S. Cl. 709/224

(57) ABSTRACT

This is achieved in an arrangement of a network forming a network topology with network components connected via data lines of a computer with an operating system and holding software for detecting the network components and the network topology is stored. An analysis tool is connected at a connection to the network to be examined and includes a computer and software developed for this combination and stored on this computer. This analysis tool has a processing unit, an integrated or external display, a network card for exchange of data via the connection with the network components in the network to be examined, and programming for automatically detecting all of the network components connected to one another in the network using the network card for automatically detecting all of the active switching nodes in the network via the connection with the network.

### FIELD OF THE INVENTION

The present invention relates to a network structure. More particularly this invention concerns a method of and apparatus for detecting and determining in an industrial setting the availability of a network structure with active connection nodes.

### BRIEF DESCRIPTION OF THE DRAWING

The above and other objects, features, and advantages will become more readily apparent from the following description, reference being made to the accompanying drawing in which:

FIGS. 1-4 are schematic diagrams of standard prior-art networks;

FIGS. 5-10 illustrate the calculations necessary for calculating network availability;

FIG. 11 is view illustrating the system of this invention; and

FIG. 12 is a view of a detail of FIGS. 11.

### BACKGROUND OF THE INVENTION

In industrial installations, components for the automation of the installations are connected via networks to an increasing extent. Installations of this type can be, for example automation installations for production engineering or process engineering processes

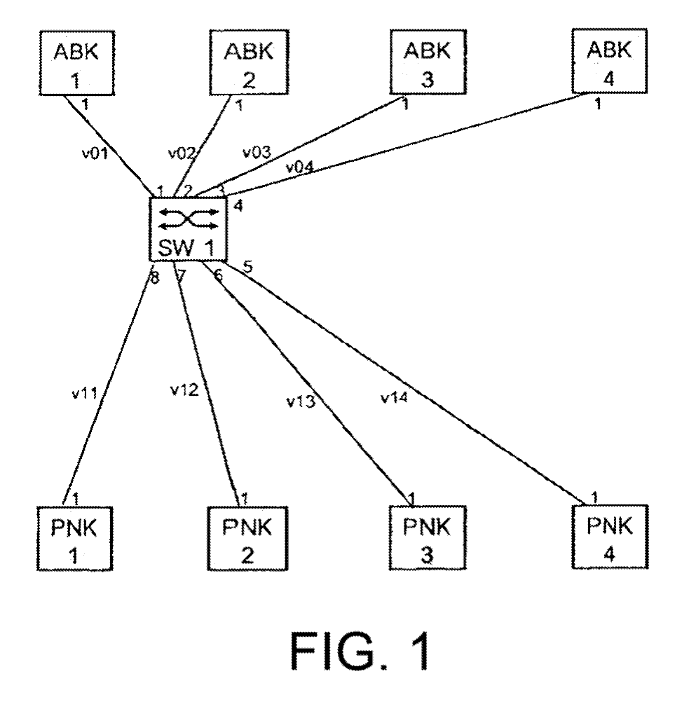

FIG. 1 shows as an example an automation installation in which the network has a star topology with an active switching node. This can be, for example an Ethernet-based network using uses so-called network switches as active switching nodes. The process-oriented components PNK1 through PNK4, for example programmable logic controllers, are here connected via a central switching node or switch SW1 to the display and control components ABK1 through ABK4. The connections V1 through V4 and V11 through V14 between the components can be executed in various technologies, for example copper cable, optical fiber cable, plastic optical waveguides or wireless connections can be used. FIG. 1 further shows that the central switching node SW1 represents a critical component whose failure can bring down the entire system.

In the case of automation installations of this type, the availability of the network plays an increasingly important role, since the network is essential for the function of industrial installations. As a rule, breakdowns in network communication lead to the shutdown of the industrial installation. Therefore increasingly high demands are being made on networks in terms of availability in order to ensure high availability of the installation.

For this reason attempts are being made through the technical configuration of the network to construct structures that have high availability. To this end, these installations are equipped with redundant communication systems with increasing frequency, to compensate for the failure of an infrastructure device or a connection without relevant data loss by diversion of the data traffic to a redundant path. Various structures are hereby used, for example, fully parallel construction of all network components, ring topology or mesh topology.

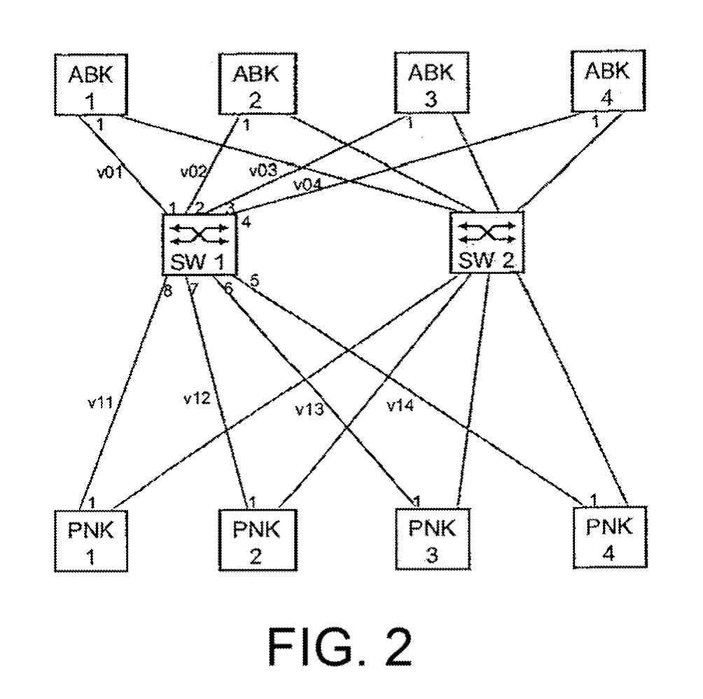

FIG. 2 shows as an example a redundant star topology for a network that here has now two active switching nodes SW1 and SW2. This can also be, for example an Ethernet-based automation system. Because of the redundant provision of the central switching component and the doubling of the connections between the central nodes and the terminal devices of the network and the redundant realization of the switches and cable connections, in the event of a breakdown it is possible to switch over to alternative data paths.

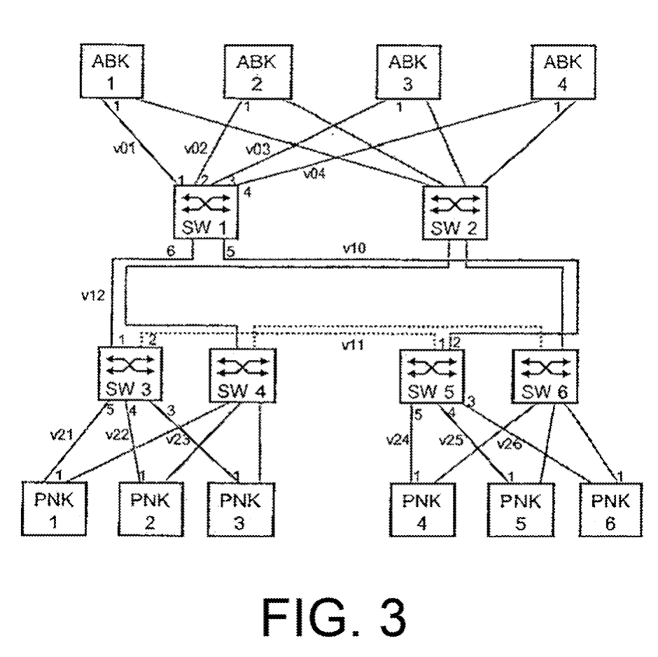

FIG. 3 shows as a further example a redundant ring topology. Here the communication nodes or switches SW1-SW6 are connected to one another in ring, so that further alternative data paths V10-V12 are produced, to which it is possible to switch in the event of a breakdown.

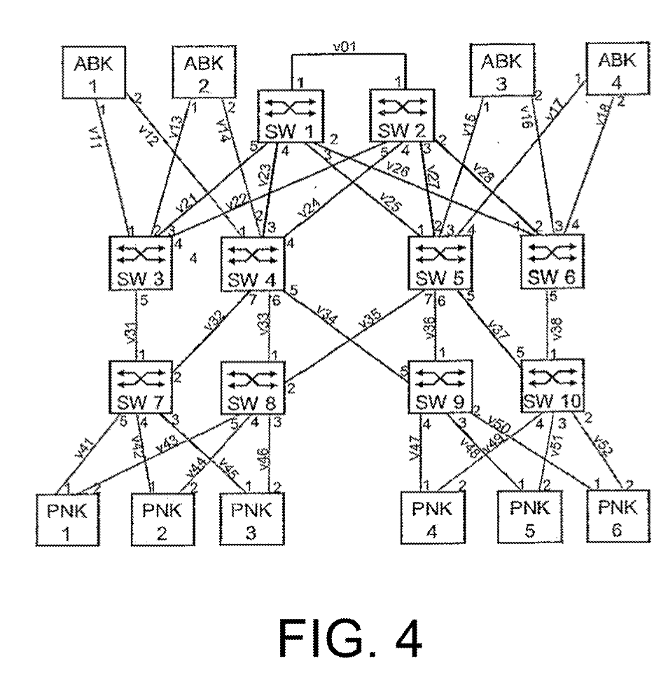

FIG. 4 shows as a further example a so-called mesh network. Here the possibility of using alternative data paths has been further increased through the addition of further alternative data paths V13-V52.

In the literature (Niemann, K.-H.: Vergleichende Untersuchung von Netzwerktopologien für Automatisierungssysteme [Comparative Study of Network Topologies for Automation Systems]. 4^{th} Industrial Ethernet Congress. 4-5 Jul. 2006, Stuttgart. Released on CD; Niemann, K.-H.: Überlegungen zur Topologie von Automatisierungsnetzwerken [Thoughts on the Topology of Automation Networks]. Part 1: Grundlagen und Stand der Standardisierung von Netzwerktopologien [Principles and Status of Network Topologies]. In atp Automatisierungstechnische Praxis 9/2006. Oldenbourg Verlag, Munich, 2006. p. 50-56; Niemann, K.-H.: Überlegungen zur Topologie von Automatisierungsnetzwerken [Thoughts on the Topology of Automation Networks]. Part 2: Kosten und Performanceanalyse [Costs and Performance Analysis]. In atp Automatisierungstechnische Praxis 10/2006. Oldenbourg Verlag, Munich, 2006, p. 64-72) there are comparative examinations that determine the reliability of different network topologies on a qualitative basis, but that do not give any concrete quantitative data on the availability of individual paths.

For the planning of a network, however, it is of great interest to obtain quantitative figures with respect to the availability of different network topologies in order to thus give the planner or operator (administrator) selection ideas for planning a network with high availability.

Special tools for calculating the availability of automation networks with active switching nodes are not currently available on the market. A manual calculation of the availability can be provided only for the simplest structures without meshes in finite time and are therefore not usable for larger networks because of errors and the effort involved. Furthermore, the collection of reliability characteristics necessary for an availability calculation is very expensive and time-consuming. At the same time, the determination of the availability of these networks is very complex and therefore error-prone.

First, some basic terms of reliability calculation are introduced below. Then the individual components of an automation installation are examined, which then are connected via the network to form an overall installation.

First, an individual device, for example a network switch or also a PLC (programmable logic controller) is considered below. This is an electronic device that can be ordered from a supplier ready to use. As a rule, this electronic device is composed of one or more printed-circuit boards as well as electronic components and a housing. For the definition of the reliability of a device of this type, the so-called MTTF (mean time to failure) can be used as a characteristic. For the MTTF a failure rate λ constant over time is assumed. The MTTF is then calculated from the equation:

MTTF=1/λ.

The MTTF defines a statistical number that characterizes the time interval of breakdowns of a device. The MTTF is determined by the manufacturer of a device based on standardized calculation methods (for example MIL-HDBK-217, Telcordia Standard). For the calculation of the MTTF of a device, calculation tools are available that can be ordered from various manufacturers. The tool λPredict by ReliaSoft is cited here by way of example.

Important influencing factors for the level of the MTTF are:
Number and type of the components,
Operating temperature, and
Other ambient conditions.

To simplify matters, it can be that the failure rate λ rises with increasing complexity and increasing temperature. The MTTF falls correspondingly at the same time.

Typical MTTF values for network switches are in the range of several years, for example.

As the second important characteristic, the term of the MTTR is now introduced. MTTR is the abbreviation for the term “Mean Time to Recover.” This time is defined as the average time needed for the repair or replacement of a defective device.

The MTTR is essentially determined by the service organization of the operating company and possible by the manufacturer. Important influence factors are, e.g.:
Time needed to find the defective device, and
Time needed to replace/repair the defective device

If necessary, in the case of replacement, the lead time for spare parts if immediate repair is not possible must be factored in.

Typical MTTR values lie in the range of hours to days, depending on the service organization of the installation operating company.

The MTBF can be calculated from the MTTF and the MTTR. The MTBF is the abbreviation for the term “Mean Time Between Failure” and is defined as follows:

MTBF=MTTF+MTTR

The availability of an individual device can now be determined from the MTBF and the MTTR using the following formula

F=MTTF/MTBF=MTTF/(MTTF+MTTR)=No-failure time/Overall time

The availability V can take on values between zero and one. As can be seen from this formula, high availability are achieved when the value for the MTTF is very large relative to the MTTR, or, to put it another way, through a high reliability of the devices in connection with short replacement or repair times.

It is assumed below that the availability figures for all of the components used in a system are known. The MTTF figures necessary for this are generally provided by the supplier of the devices, the MTTR values come from the service organization of the user.

As a rule, an automation installation is composed of a multiplicity of individual devices interconnected by a network to form an installation. If there are several devices between two end points that maintain a communication relationship with one another, the availability of these devices is involved in the availability of the overall connection.

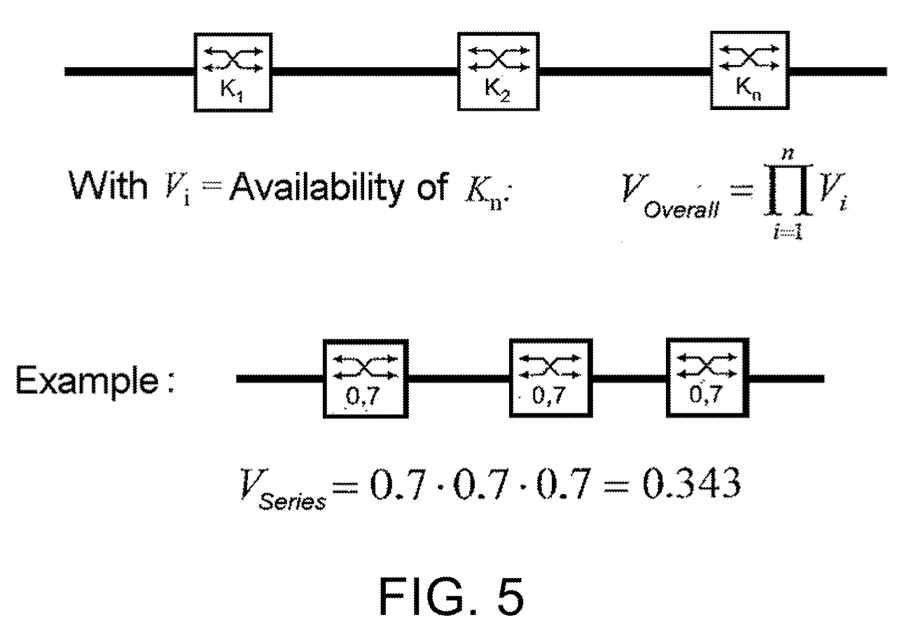

FIG. 5 shows a connection in series of three network switches K₁, K₂, and K₃. The overall availability of the series connection is calculated from the product of the individual availabilities. This makes sense because each of the switches in the series connection can break down and thus the breakdown of an individual switch increases the failure probability of the overall arrangement. As can be seen from FIG. 5, the resulting availability of the series connection is lower than that of the individual components.

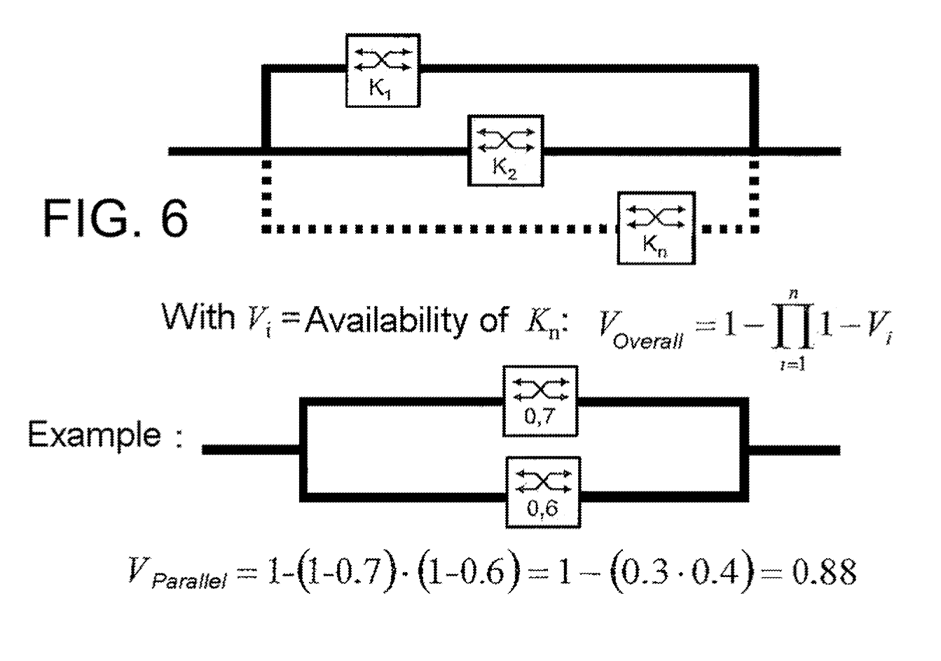

FIG. 6 shows the calculation method for calculating the availability of a parallel connection. As can be seen, the overall availability of the arrangement is increased in this parallel arrangement. This increase is used in the configuration of redundant networks. Alternative routes are produced by the parallel paths and can be used in the event of a breakdown of individual components. The availability of the arrangement is increased by the parallel connection of network paths.

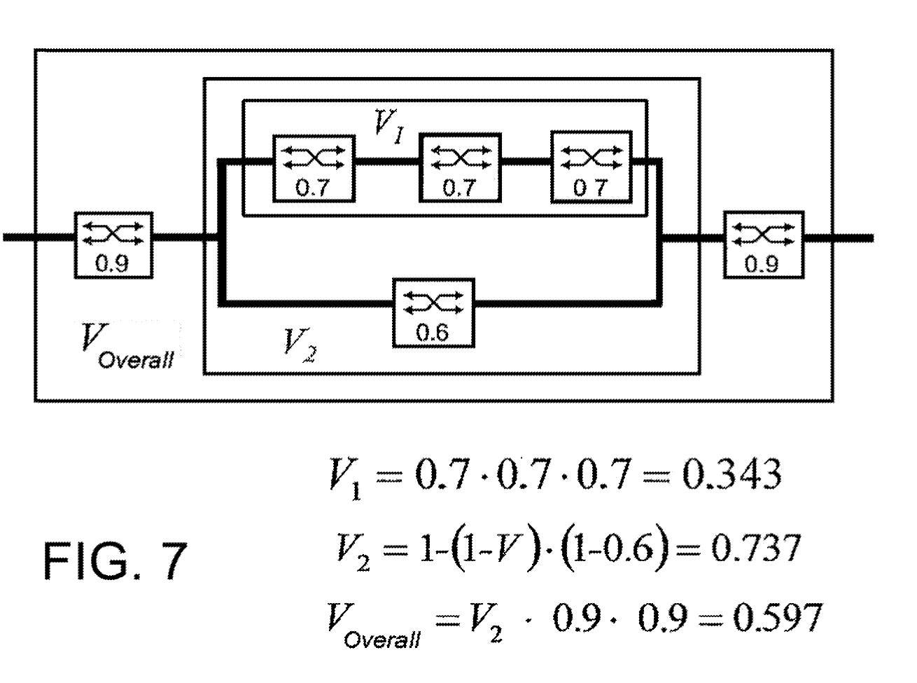

FIG. 7 shows that with mixed topologies the calculation methods for series and parallel connections can be combined in order to determine the availability of the overall arrangement.

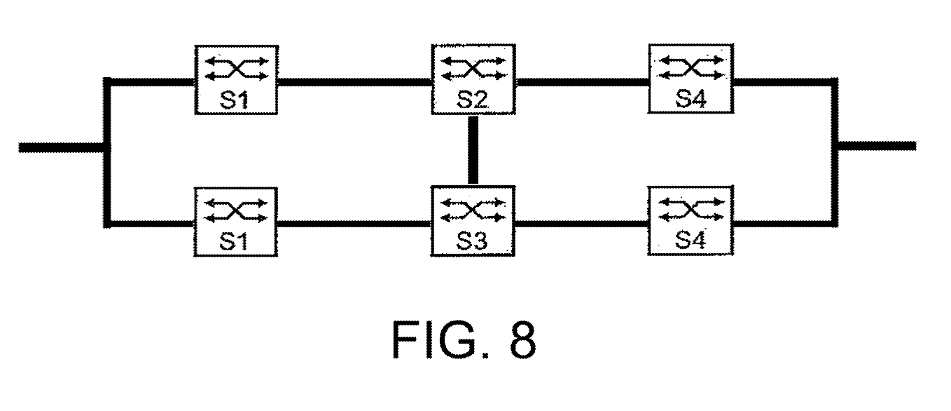

As FIG. 8 shows, the method of reliability calculation by resolution to series connections and parallel connections does not work in the case of mesh connections or ring topologies. These cannot be broken down into equivalent series connections or parallel connections. However, ring topologies or mesh topologies regularly occur in automation technology. To calculate topologies of this type, other methods of reliability calculation must be used.

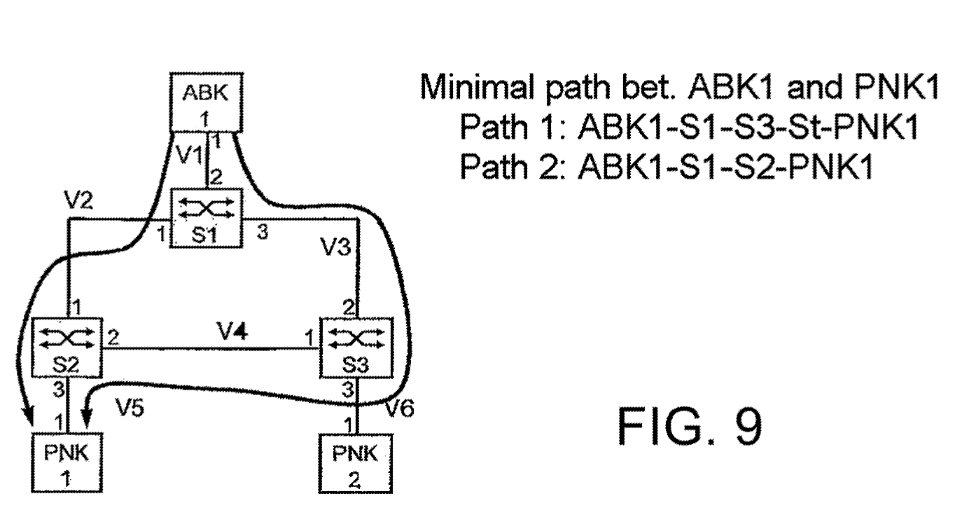

According to a method of this type, the minimal paths between the two points to be examined are sought. FIG. 9 shows as an example a ring network. The availability of the network between points ABK1 and PNK1 is to be examined. As can be seen, paths 1 and 2 are available for the exchange of data. In this examination it is irrelevant that in undisturbed operation one of the ring connections (for example V4) is temporarily disconnected and is activated only in the event of a breakdown. For the availability calculation it is important only that the connection is activated at the decisive moment through corresponding algorithms (for example Redundant Ring Protocols or the Rapid Spanning Tree Protocol).

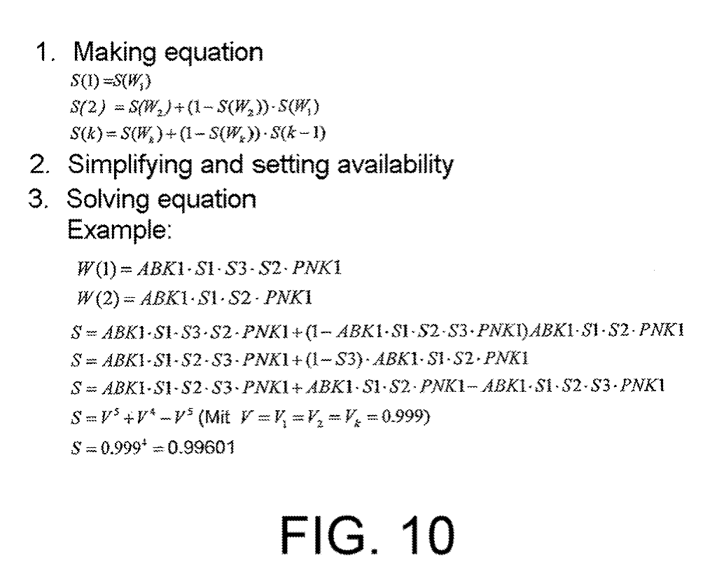

FIG. 10 shows how, using this minimal-path method, the availability of the network can be determined taking into consideration two paths. In this example it is assumed to simplify matters that all of the components have the same availability. It is discernible that the method for a simple network with two possible paths already leads to correspondingly complex system equation S. It makes sense that with a mesh network, such as shown for example by FIG. 4, the complexity of the system equation will increase drastically, since there is a multiplicity of parallel paths in a network of this type that are included in the system equation.

For this reason, an error-free calculation of the availability of a topology of this type cannot be made by hand with a finite expenditure of time. A calculation using an is automated method is necessary.

Solutions for the reliability calculation of general technical interconnections are available on the market (ReliaSoft Corporation (ed.): Company brochure Blocksim 7. http://www.reliasoft.com/pubs/blocksim7_brochure.pdf ReliaSoft Corporation, Worldwide Headquarters, 1450 South Eastside Loop, Tucson, Ariz. 85710-6703).

However, these have several disadvantages:
The topology to be examined must be entered manually into the calculation tool. This means in particular with complex networks with thousands of network nodes a huge expenditure of time and a high error potential from incorrect entries.
The topology to be examined must be determined from documentation free of errors and reflecting the current state of the system. Deviations between the documentation and the network actually available are not recognized.
As a rule, the tools on the market can be operated only by specially trained staff. The manufacturer offers, for example special training courses for this.
The method on which these tools are based is frequently based on the Monte Carlo Simulation. That means that the results simulate a technical system with the aid of random processes. Here the precision of the result depends on the duration of the simulation.
The MTTF and MTTR values must be entered individually for each component in the system. This can mean considerable effort in the case of networks with thousands of network nodes.
The MTTF and MTTR data for all of the components used in a system must be obtained from the suppliers or operating companies.

In conclusion, it can be seen that although in general the calculation of the availability of networks with active switching nodes can be achieved with calculation tools available on the market, the expenditure of time associated therewith for the entry of the network components, the network topology and the reliability characteristics is disproportionately great, in particular for large networks.

### OBJECTS OF THE INVENTION

It is therefore an object of the present invention to provide an improved detecting and determining availability of a network structure.

Another object is the provision of such an improved detecting and determining availability of a network structure that overcomes the above-given disadvantages, in particular where the disadvantages described above are avoided and the use of technical systems or arrangements of this type is markedly is improved.

### SUMMARY OF THE INVENTION

This is achieved in an arrangement of a network forming a network topology with network components connected via data lines of a computer with an operating system and holding software for detecting the network components and the network topology is stored. According to the invention an analysis tool is connected at a connection to the network to be examined and includes a computer and software developed for this combination and stored on this computer. This analysis tool has a processing unit, an integrated or external display, a network card for exchange of data via the connection with the network components in the network to be examined, and programming for automatically detecting all of the network components connected to one another in the network using the network card for automatically detecting all of the active switching nodes in the network via the connection with the network.

According to the method according to the invention the detected network topology is transferred to a calculation module of the computer for availability calculation.

### SPECIFIC DESCRIPTION

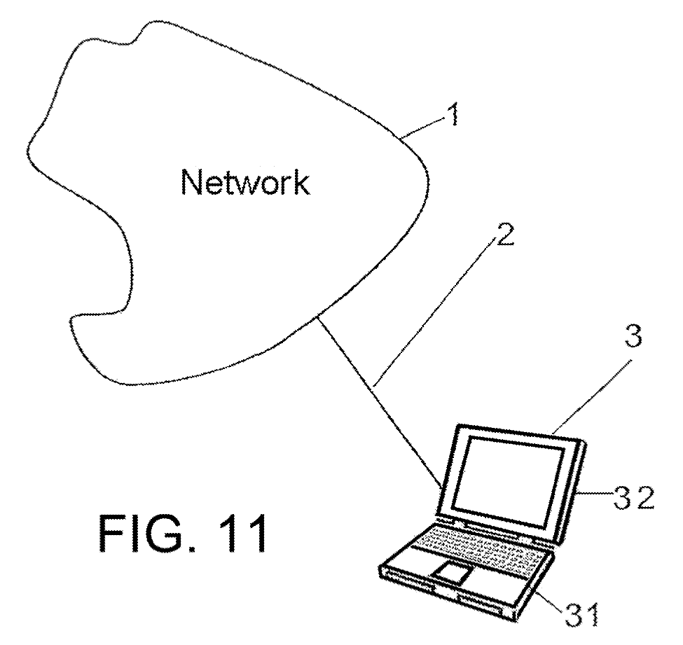

As seen in FIG. 11 an analysis tool 3 is connected to the network 1 to be examined via a connection 2. This analysis tool 3 is composed of a commercially available PC or laptop and software developed for this arrangement.

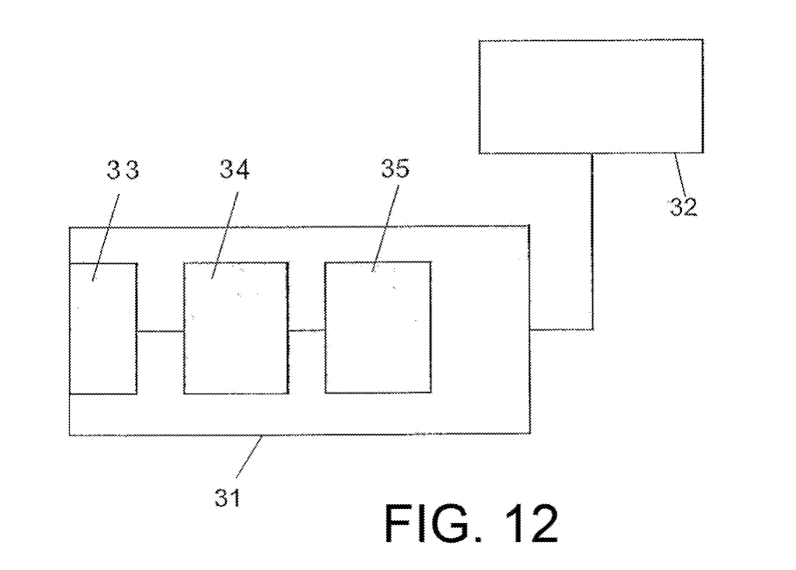

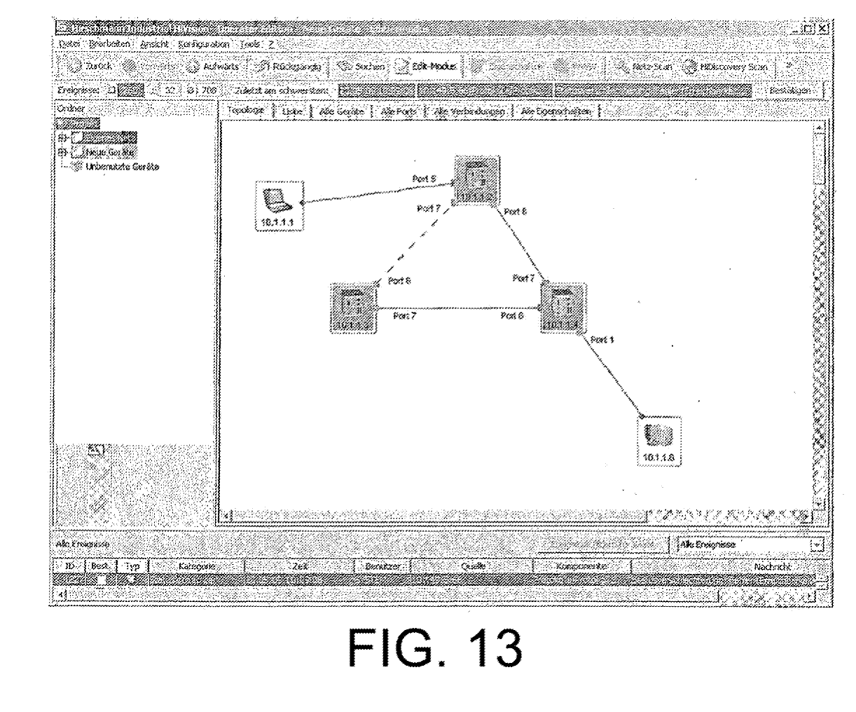

The analysis tool 3 in FIG. 11 is composed of a processing unit 31 and an integrated or external screen 32. The processing unit has a network card 33 so that data can be exchanged via the connection 2 with the components in the network 1 to be examined (see also FIG. 12).

The software on the analysis tool 3 initially has the following functionality:
An automated detection of all of the components connected to the network 1 takes place via the module 34 using the network card 33 via the connection to the network 2
At the same time, an automated detection of all of the active switching nodes in the network 1 is carried out via the connection 2 with the network.

Network management systems such as, for example the Hirschmann “Industrial HiVision” software determine for example infrastructure devices in the network with protocols, such as for example ICMP or SNMP and thus take over the functionality of the module 34. The infrastructure devices themselves exchange information on the topology, for example by means of the Link Layer Discovery Protocol and make this information available via the integrated Management Information Base (MIB). A network management system such as, for example Industrial HiVision can thus read out, collect, store, and graphically display the data regarding the topology of the network.

FIG. 13 shows by way of example the view of a simple network comprising a laptop, a PC and three active switching nodes.

The described software functionality is expanded by a functionality in which the reliability characteristics (MTTF, MTTR) of the devices are already stored in the module 34 and thus do not need to be entered manually. Alternatively, these characteristics can also be read out of the devices themselves. In the event that no reliability characteristics have been stored in the system for certain types of devices, these can be entered manually. For identical device types the data can thereby be assigned in a simplified manner via cluster management functions. The same applies to the reliability characteristics of connections such as for example copper or optical fiber cables.

The network management software 34 transfers the collected data to the availability calculation module 35, which calculates the availability therefrom and outputs the value including the calculation and additionally stores it in a suitable manner. Availability can hereby be calculated between any two points of the network. The result is either shown by the module 35 or transferred to the calling module 34 and shown, stored and if required printed out by it.

A network component is also referred to as device, infrastructure device or the like.

Essential and important aspects of the invention are summarized again in outline below:
1. Arrangement for the detection of network topology and subsequent calculation of availability:
2. The arrangement is composed of a commercially available PC or laptop with any operating system, on which software for the detection of the network components and the network topology is stored and which furthermore is composed of a further component for calculating network availability.
3. The PC can be operated with any operating system, for example Microsoft Windows or Linux.
4. The arrangement is connected to the network at one point at least.
5. The type of transmission medium between the network and the PC is random (optical fiber cable, copper cable, wireless).
6. The arrangement detects, collects, stores, displays graphically via certain services the components and connections in the network and prints them out if required.
7. The detected network topology is transferred to a calculation module for the availability calculation, which module operates on the same computer.
8. The calculation module calculates the availability of the network from the detected network components and the detected network topology and with reliability characteristics stored in the device.
9. The calculation of the availability of the network can be carried out between any two points and the result displayed on the screen and additionally stored on the computer and, if required, printed out on a printer.
10. The points between which the calculation is carried out do not need to be end points, but can also be active switching nodes.
11. The calculation can cover only the network or also the network with the components connected thereto (terminal devices).
12. The reliability data of the network components and terminal devices are stored in the tool by the manufacturer and do not need to be entered manually.
13. The reliability data of the network components and terminal devices can also be entered manually if they have not been provided by the manufacturer of the software for certain devices or device classes.
14. The reliability data of the network components and terminal devices can also be changed if desired by the user.
15. Reliability characteristics entered or changed manually can be stored and are available again for subsequent calculations.
16. Data sets of reliability data of devices can be expanded and/or updated with the software update of the device.
17. This update can be carried out via storage media or the Internet or in another manner.
18. Data sets of reliability data of devices can be individually expanded and/or updated independently of the software update of the device.
19. This update can be carried out via storage media or the Internet or in another manner.
20. The reliability data of the network components and terminal devices can also be read out of the devices via the network, if these devices support the corresponding functionality.
21. The examined network may, but does not necessary have to, contain active switching nodes (for example network switches or routers).
22. The arrangement can also be operated in an offline mode without connection to the network, in that the network topology can be entered manually.
23. In this case the arrangement can have a text or graphic editor in which the network components and the network topology can be entered, processed, stored and printed out.
24. After a calculation in offline operation, the arrangement can subsequently check the conformity with the network realized later and display deviations, if a connection to the realized network can be produced at a later time. In this case, the arrangement can optionally calculate the deviation of the availability between planned and realized network availability.
25. The arrangement can calculate an availability figure by selection, if the existing network topology is designed redundantly.
26. The arrangement can be composed not only of one single computer, but also of an interconnection of several computers to divide up the computing work and thus to shorten the computing time.
27. The arrangement can be composed not only of one single computer, but also of an interconnection of several computers, wherein the determined topology of a computer coupled to the network is determined and then transferred via a connection to another computation node for calculation. This computation node calculates the availability figure and delivers the result back to the calling computer (client server principle).
28. This computer (server) can also be spatially distant to calculate the availability (connection to the server via the Internet).
29. The operator interface of the arrangement can support several languages.
30. The operating instructions are integrated into the product such that the user can read them on the screen of the analysis tool.
31. The operating instructions can be realized in several languages.
32. The language of the interface and operating instructions can be selected during the installation of the software or during operation

We claim:

1. In combination:
a network forming a network topology with network components connected via data lines,
a computer with an operating system and holding software for detecting the network components and the network topology is stored, and
an analysis tool is connected at a connection to the network to be examined and includes a computer and software developed for this combination and stored on this computer.

2. The combination defined in claim 1 wherein the analysis tool has
a processing unit,
an integrated or external display
a network card for exchange of data via the connection with the network components in the network to be examined, and
means for automatically detecting all of the network components connected to one another in the network using the network card for automatically detecting all of the active switching nodes in the network via the connection with the network.

3. A method for determining availability of network components, in an arrangement comprising
a network forming a network topology with network components connected via data lines and a computer with an operating system and holding software for detecting the network components and the network topology is stored,
a further component for calculating the network availability,
the comprising the steps of:
connecting via a connection to the network to be examined and analysis tool is composed of a computer and software developed for the arrangement and stored on this computer, and
transferring the detected network topology to a calculation module of the computer for availability calculation.

4. The method defined in claim 3 wherein the analysis tool has
a processing unit,
an integrated or external screen,
a network card that exchanges data via the connection with the network components in the network to be examined, and
a module for automatically defecting all of the network components connected to one another in the network via the network card and for at the same time automatically detecting all of the active switching nodes in the network via the connection with the network.

5. The method defined in claim 4, further comprising the step of
storing reliability characteristics of the network components in the module.

6. The method defined in claim 5, further comprising the step of
reading the reliability characteristics read out of the network components for storage in the module.

7. The method defined in claim 5, further comprising the step of
manually entering the reliability characteristics of the network components into the module.
